(19) United States
(12) Patent Application Publication
(10) Pub. No.: US 2023/0410825 A1
(43) Pub. Date: Dec. 21, 2023

(54) Masking the voice of a speaker

(71) Applicant: MUSICIENS ARTISTES INTERPRETES ASSOCIES - M.A.I.A., Boulogne-Billancourt (FR)

(72) Inventors: Christophe HENROTTE, BOULOGNE-BILLANCOURT (FR); Frédéric BIMBOT, Tinténiac (FR)

(21) Appl. No.: 18/206,602

(22) Filed: Jun. 6, 2023

(30) Foreign Application Priority Data
Jun. 8, 2022 (FR) 2205507

(51) Int. Cl. G10L 21/013

(52) U.S. Cl. CPC G10L 21/013

(57) ABSTRACT

A method includes masking the voice of a speaker by intentionally altering the pitch and the timbre of their voice. An audio signal corresponding to an original recording of the voice of the speaker is divided (11) into a series of successive audio segments of a determined constant duration. A rising frequency alteration (12a) is applied to a timbre (A) extracted from each audio segment. A falling frequency alteration (12b) is applied to a pitch (B) extracted from each audio segment. The altered pitch and the altered timbre of the audio segment are combined (14) so as to form a single resulting altered audio segment. From one audio segment to another in the series of audio segments, a variation (13a) of the rising alteration and a variation (13b) of the falling alteration are applied. These variations fluctuate randomly from one audio segment to another in the series of audio segments.

### RELATED APPLICATION

This application claims the benefit of French Patent Application No. 22 05507, filed on Jun. 8, 2022, the entirety of which is incorporated by reference.

### Field of the Invention

The present invention relates to masking the voice of a speaker, in particular in order to protect the identity of the speaker by restricting the possibility of identifying them by analysing an original recording of their voice.

It is applicable in particular in audio or audiovisual editing and/or mixing systems in which it may be implemented by audio processing software.

### Description of the Related Art

In some sectors of the audiovisual industry, for example, it is useful to be able to broadcast programmes (audio and/or video and/or multimedia content) while concealing the identity of the speaker in order to protect said speaker from all types of consequences of this broadcasting that may be detrimental to them. For example, in investigative journalism, it is common to anonym ize the recording of the interview of a witness that could be used against their interests, either by the perpetrators of the offences they are reporting, or by litigants or by a competent legal body if the witness is recognized as having infringed any regulations there.

Techniques aimed at anonym izing the voice of a speaker in an audio signal, that is to say making it difficult to identify the speaker based on analysis of the audio signal, are long known. The oldest and most commonly used one makes do with transforming the voice of the speaker through a simple harmonic shift. This shift may be carried out either towards high frequencies, that is to say towards high pitches, or towards low frequencies, that is to say towards low pitches. With reference to characters from fictional audiovisual programmes well known to the general public, it is sometimes said that the voice thus transformed is similar to the voice of “Mickey Mouse”™ or else to the voice of “Darth Vader”™, which are generated using such techniques based on the voice of a real person. However, the transformation of the voice that is thus obtained is easily reversible using technical means that are nowadays accessible to many people, if not to everyone.

Moreover, voice recognition software, or more particularly speaker recognition software, based on the voice signature of said speaker, is sometimes used by the police to identify people making telephone threats or at the origin of anonymous calls. Now, there is nowadays certain software of this type that makes it possible to identify a speaker with a high reliability level, such that it may lead to a person being sentenced by the justice system. Although such use may seem laudable from the community point of view, malicious use of such software may have consequences for individuals that are far less so, possibly creating harm that is sometimes irrecoverable, such as in terms of invasion of privacy. It is for this reason that audio processing techniques may be used to protect speakers the recording of whose voice is liable to be broadcast or intercepted on communication networks.

Lastly, another case in which it is desirable to protect speakers is that of voice input applications using speech recognition to allow users to access services. Speech recognition is used to recognize what is said. It therefore makes it possible to transform speech into text, and it is for this reason that it is also known by the name speech-to-text conversion.

The article “Voice Mask: Anonymize and Sanitize Voice Input on Mobile Devices” published in the scientific review COMPUTER SCIENCE, CRYPTOGRAPHY AND SECURITY, Cornell University, US, 30 November 2017, pages 1-10, Jianwei Qian et al., thus discloses that, with hands-free communication, voice input has largely replaced the use of conventional touch keypads (for example, the virtual keypads Google®, Microsoft®, Sougou™ and iFlytek™). These techniques are used daily by many users to perform voice searches (with for example applications such as Microsoft Bing®, Google Search®), and personal assistants based on artificial intelligence (for example Siri® from Apple®, and Amazon Echo®), with a wide range of mobile apparatuses. In these applications, due to the limited resources on mobile apparatuses, the speech recognition operation is generally exported to a cloud computing server for greater precision and increased efficiency. As a result, the privacy of users may be compromised. Indeed, even though, in these applications, only the content of the speech needs to be recognized by the speech recognition, it has become easy to carry out recognition of the speaker in order to recognize regular mobile users by their voice, via learning techniques that take advantage of recurrent use, to analyse sensitive content of their inputs via speech recognition, and then to set up their user profile on the basis of this content with the aim of providing biased responses to their requests and/or subjecting them to targeted commercial propositions. The authors of the article propose a voice neutralization application that ensures good protection of the user's identity and of the private content of speech, at the expense of minimum degradation in the quality of the voice recognition. It adopts a voice conversion mechanism that is resistant to many attacks.

The article “Speaker Anonymization for Personal Information Protection Using Voice conversion Techniques”, Proceedings of Access 2020, Digital Object Identifier, Vol.8 2020, pages 198637-198645, IEEE, US, In-Chul Yoo et al., discloses voice conversion in order to anonym ize a speaker with the aim of conserving the linguistic content of the given speech while at the same time removing biometric data of the voice of the original speaker. The proposed method modifies the conventional identity vectors of the speaker to anonymized identity vectors of the speaker using various methods.

The article entitled “Speaker Anonymization Using X-vector and Neural Waveform Models”, Proceedings of 10th ISCA Speech Synthesis Workshop, 20-22 Sep. 2019, Vienna, Austria, pages 155-160, Fuming Fan et al., proposes a speaker anonym ization approach for concealing the identity of the speaker while at the same time maintaining a high anonymous speech quality, which is based on the idea of extracting the linguistic and identity characteristics of the speaker of a statement, and then using them with acoustic neural and waveform models to synthesize the anonymous speech. The original identity of the speaker, in the form of timbre, is removed and replaced with that of an anonymous pseudo-identity. The approach uses advanced representations of the speakers in the form of X-vectors. These representations are used to derive anonymous speeches. These are used to derive pseudo-identities of anonymous speakers by combining multiple X-vectors of random speakers.

The authors of the article entitled “Exploring the Importance of FO Trajectories for Speaker Anonymization using x-vectors and Neural Waveform Models”, International Audio Laboratories, Erlangen, 2021, Workshop on Machine Learning in Speech and Language Processing (MLSLP), 6 September 2021, ISCA, DE, pages 1-6, UE Gaznepoglu et al., considering the presence of personal information in the various components of the fundamental frequency F0 of the voice of a speaker and the availability of various approaches for modifying the component FO, propose to explore their potential in the context of voice anonym ization. They suggest that decomposing the component F0, modifying the characteristics linked to the speaker, disturbing them possibly with noise during the process, and then resynthesizing them, could increase anonym ization performance and/or improve intelligibility. It is mentioned that the approaches proposed up until now, such as shifting and scaling, all depend on the identity of the person to be protected.

The article “Speaker anonymization using the McAdams coefficients” in the review COMPUTER SCIENCE, AUDIO AND SPEECH PROCESSING, Cornell University, US, September 2021, pages 1-5, Patino J et al., explains the reversibility of anonymization. The authors present therein their work that is aimed at exploring in greater depth the potential of well-known signal processing techniques as a solution to the problem of anonym ization, as opposed to other more complex and more demanding solutions that require training data. They suggest optimizing an original solution based on McAdams coefficients to modify the spectral envelope (that is to say the timbre) of speech signals. They sought to confirm that various values of the McAdams coefficient a (alpha) that modify the timbre of the voice are able to produce various pseudo-voices for one and the same speaker. This results in a stochastic approach to the anonym ization in which the McAdams coefficient is sampled within a uniform distribution range, that is to say α ∈ (αmin,αmax). However, in the proposed applications, the article makes do with teaching that the coefficient a may be changed randomly from one speaker to another, while indicating that a malicious third party would then need to ascertain the exact McAdams coefficient used to anonym ize the speech of any speaker in particular in order to reverse the transformation.

There is therefore still a need for a technique for masking the voice of a speaker that is not able to be overcome easily.

### Objects and Summary

A first aspect of the proposed invention relates to a method for masking the

voice of a speaker in order to protect their identity and/or their privacy by intentionally altering the pitch and the timbre of their voice, comprising: dividing an audio signal corresponding to an original recording of the voice of the speaker into a series of successive audio segments of a determined constant duration, and forming a series of pairs of audio segments each comprising a primary version and a duplicate of an audio segment of said series of audio segments; and,

for each pair of audio segments:

processing the primary version of the audio segment and processing the duplicate of the audio segment in order to extract therefrom a signal characterizing the pitch of the audio segment, on the one hand, and a signal characterizing the timbre of the audio segment, on the other hand;

a first alteration, applied to the signal characterizing the timbre extracted from the audio segment, and having the effect of altering all or part of the envelope of the harmonics of said audio segment, so as to generate an altered timbre of the audio segment;

a second alteration, applied to the signal characterizing the pitch extracted from the audio segment, and having the effect of altering the value of the fundamental frequency, so as to generate an altered pitch of the audio segment;

one of the alterations out of the first alteration and the second alteration being a rising alteration, while the other alteration is a falling alteration; and

combining the altered timbre of the audio segment and the altered pitch of the audio segment, so as to form a resulting altered audio segment, the method furthermore comprising, from one pair of audio segments to another in the series of pairs of audio segments;

varying the first alteration; and

varying the second alteration,

said variations of said first and second alterations fluctuating randomly from one pair of segments to another in the series of pairs of audio segments, and the method furthermore comprising:

recomposing a masked audio signal from the series of altered audio segments.

By virtue of this method, the voice is masked, making it possible to respond to the requirement to protect the one or more speakers, since the method is easily able to be implemented in any first equipment involved in the audio acquisition and processing chain. At the same time, the method makes it possible to have a final rendering that remains intelligible, that is to say that is neither a “Mickey Mouse”™ voice nor a “Darth Vader” ™ voice, due to the two alterations applied to each audio segment, which produce modifications in the frequency content that are in a direction contrary to one another. Indeed, a rising effect (towards high-pitched tones) is applied to one of the two alterations and a falling effect (towards low-pitched tones) is applied to the other of the two alterations, such that these two effects combine from the point of view of the frequency content of the audio segment under consideration. The resulting masked audio segment possesses frequency content that remains overall closer, over the spectral dynamic range, to that of the original audio segment, despite the voice masking that is obtained.

Advantageously, the frequency alterations are restricted, one always being rising while the other is always falling. Therefore, the software or the device designed to implement the solution cannot itself be subject to the reverse operation.

According to the method, two components of the spectrum of the audio signal are altered simultaneously in relation to the original recording of the voice of the speaker. This is a first element that promotes the irreversibility of the method, since a malicious third party wishing to return to the original voice will have two modify these two characteristics of the voice in combination, thereby complicating the task for them in comparison with masking based on shifting just pitch.

According to another advantage, the variability of the alterations is not static. It varies over time. There may thus be multiple variations over one second of processing.

Ultimately, the proposed modes of implementation provide voice masking that is irreversible in audio mode, that is to say by a reverse audio processing operation.

Furthermore, the voice masked by the proposed method is not able to be analysed by known speaker recognition techniques, and does not expose the speaker to commercial practices that jeopardize their privacy using voice recognition techniques, given that the masked voice of one and the same speaker is never masked in the same way twice.

In some advantageous modes of implementation, the audio signal may be divided into a series of successive audio segments of a determined duration by time windowing independent of the content of the audio signal.

In some advantageous modes of implementation, the division of the audio signal may be configured such that the duration of an audio segment is equal to a fraction of a second, such that successive changes of the parameters varying the first and the second alteration occur multiple times per second.

In some advantageous modes of implementation, altering the pitch of the audio signal corresponds to varying the fundamental frequency of the audio signal by any one of the following values: ±6.25%, ±12.5%, ±25%, ±50% and ±100%.

In some advantageous modes of implementation, the first alteration and the second alteration are dependent on one another, fluctuating jointly so as to satisfy a determined criterion in relation to their respective effects on the frequency content of the timbre of the audio segment and on the frequency content of the pitch of the audio segment, respectively. For example, this criterion may consist in maintaining a minimum difference between the respective effects of the two alterations, and thus avoiding temporarily returning to the original voice.

A second aspect of the invention relates to a computer program comprising instructions that, when the computer program is loaded into the memory of a computer and is executed by a processor of this computer, are suitable for implementing all of the steps of the method according to the first aspect of the invention above.

The computer program for implementing the method may be recorded in a non-transient manner on a tangible, computer-readable recording medium.

The computer program for implementing the method may advantageously be sold as a plug-in, able to be integrated within “host” software, for example audio or audiovisual production and/or processing software such as Pro Tools™, Media Composer™, Premiere Pro™ or Audition™, inter alia. This choice is particularly suitable for the audiovisual world. Indeed, this makes it possible to do away with the need to transfer the original audio signal (which is unmasked, and therefore in open form) to a remote server or another computer. It is therefore only the user's computer that holds the source file of the original voice, that is to say before execution of the masking method. This thus greatly reduces the risk of malicious inception of the original audio signal. For all that, the method may be implemented by audio processing software that may very well be executed on independent hardware having standard processing capabilities, for example a general-purpose computer, since it is processed in real time. It does not require implementing in particular any artificial intelligence, any voice database, or any learning method, in contrast to a number of solutions in the prior art, in particular some of those that were presented in the introduction.

As a variant, the computer program for implementing the method may advantageously be integrated, either ab initio or by way of a software update, into the internal software that is embedded in an equipment dedicated to the production and/or processing of audio or audiovisual content (called “media” in the jargon of a person skilled in the art), such as an audio and/or video mixing and/or editing console for example. Such equipment is intended more for producers, mixers, and other media post-production professionals.

A third aspect of the invention relates to an audio or audiovisual processing device, comprising means for implementing the method. This device may be implemented in the form for example of a general-purpose computer able to execute the computer program according to the second aspect above.

Lastly, a fourth and final aspect of the invention relates to an audio or audiovisual processing apparatus such as an editing and/or mixing console for producing media (that is to say audio, audiovisual or multimedia content) corresponding to or incorporating a speech signal of a speaker, in particular of a speaker to be protected, the apparatus comprising a device according to the third aspect.

### BRIEF DESCRIPTION OF THE FIGURES

The following description provided with reference to the appended drawings,

which are given by way of non-limiting example, will make it easy to understand what the invention consists of and how it may be implemented. In the drawings:

FIG. 1 shows a flowchart illustrating the main steps of the method according to some modes of implementation;

FIG. 2 shows a highly simplified schematic depiction of an audio system in which the method may be implemented;

FIG. 3A and FIG. 3B show diagrams illustrating modes of implementation of the falling alteration and of the rising alteration, respectively, which may be applied to the timbre and to the pitch of an audio signal segment according to some modes of implementation;

FIG. 4A and FIG. 4B show frequency graphs of a recorded audio sequence, showing the distribution of energy as a function of frequency before and after, respectively, the implementation of a voice masking method according to the prior art;

FIG. 5A and FIG. 5B show frequency graphs of the same audio sequence as FIG. 4A, showing the distribution of energy as a function of frequency before and after, respectively, the implementation of a voice masking method according to the proposed method;

FIG. 6 shows a detailed flowchart illustrating the steps of the method according to some modes of implementation.

### DESCRIPTION OF EMBODIMENT(S)

In the figures, and unless provision is made otherwise, identical elements will

bear the same reference signs.

The human voice is all sounds produced by air friction from the lungs over the folds of the larynx of a human being. The pitch and the resonance of the uttered sounds depend on the shape and the size not only of their vocal cords, but also on the rest of the person's body. The size of the vocal cords is one of the sources of the difference between male voices and female voices, but it is not the only one. The trachea, the mouth, the pharynx, for example, define a cavity in which the sound waves emitted by the vocal cords are set in resonance. Furthermore, genetic factors are at the origin of the difference in size of the vocal cords within people of the same sex.

Given all of these characteristics, which are specific to every person, the voice of every human being is unique.

The method makes it possible to mask the voice of a speaker for the purpose of protecting their identity and/or their privacy.

Hereinafter, original speech signal is the name given to the audio signal corresponding to an acquired sequence of the non-deformed voice of the speaker. A masked audio signal is understood to mean the result of the processing of the original speech signal obtained by implementing the method.

According to the modes of implementation as proposed, the identity and/or the privacy of the speaker is protected by intentionally altering not only the pitch but also the timbre of the voice of the speaker. This alteration is carried out using digital signal processing techniques, based on computer-implemented processing algorithms.

A complex sound with a fixed pitch may be analysed as a series of elementary vibrations, called natural harmonics, the frequency of which is a multiple of that of the reference frequency, or fundamental frequency. For example, if consideration is given to a fundamental frequency having a value f, the waves having the frequency 2f, 3f, 4f, j×f and so on are considered to be harmonic waves. The fundamental frequency (from which the frequencies j×f of the harmonics stem) characterizes the perceived pitch of a note, for example a “la”. The distribution of the intensities of the various harmonics according to their rank j, characterized by their envelope, defines the timbre. The same applies to a speech signal as for musical notes, speech being nothing more than a succession of sounds produced by the vocal tract of a human being.

It will be noted that the timbre of a musical instrument or of a voice denotes all

of the sound characteristics that allow an observer to identify by ear the sound produced, independently of the pitch and of the intensity of this sound. Timbre makes it possible for example to distinguish the sound of a saxophone from that of a trumpet playing the same note with the same intensity, these two instruments having natural resonances that distinguish the sounds to be listened to: the sound of a saxophone contains more energy on the relatively lower-frequency harmonics, thereby giving a timbre with a relatively more “muffled” sound, while the timbre of the sound of a trumpet has more energy on the relatively higher-frequency harmonics so as to give a “sharper” sound, even though said sound has the same fundamental frequency. For voice, vocal register denotes all of the frequencies uttered with an identical resonance, that is to say the part of the vocal range within which a singer, for example, utters sounds of respective pitches with a timbre that is roughly identical.

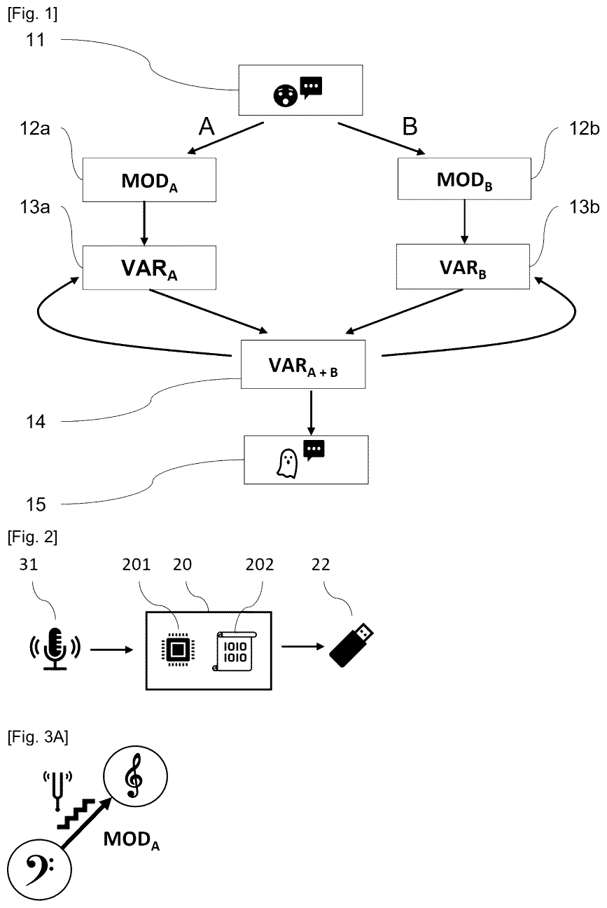

The flowchart of FIG. 1 schematically illustrates the main steps of the

method for masking the voice of a speaker. The method may be implemented in an audio system 20 as shown highly schematically in FIG. 2. This system may comprise hardware means 201 and software means 202 enabling this implementation.

It will be noted that, although the invention relates to the masking of a speech

signal, which is by nature an audio signal, this signal may belong to an audiovisual programme (mixing sound and images), such as a video of the interview of a witness wishing and/or needing to remain anonymous, facing for example a “hidden camera” or accompanied by blurring of an image of the witness to be protected. In other words, the speech signal may correspond to all or part of the soundtrack of a video, and generally any audio, radio, audiovisual or multimedia programme.

The audio system 20 is for example an audiovisual mixing equipment, used to edit video sequences in order to produce an audiovisual programme from various video sequences and their respective “soundtracks”.

The hardware means 201 of the audio system 20 comprise at least one computer, such as a microprocessor associated with random access memory (or RAM), and means for reading and recording digital data on digital recording media (mass memory such as an internal hard drive), and data interfaces for exchanging data with external peripherals. FIG. 2 symbolically shows an audio signal acquisition peripheral 31 such as a microphone, along with a data storage peripheral 22 such as a USB stick. As a variant or in addition, the system 20 may communicate in read mode and/or in write mode with other external data media in order to read on the data of an audio signal to be processed and/or to record thereon the data of the audio signal after processing. As a variant or in addition, the system 20 may furthermore comprise communication means such as a modem or an Ethernet, 4G, 5G, etc. network card, or else a Wi-Fi or Bluetooth® communication interface.

The software means 201 of the audio system 20 comprise a computer program that, when it is loaded into the random access memory and executed by the processor of the audio system 20, is designed to execute the steps of the method for masking the signal of a speaker.

With reference to the flowchart of FIG. 1, in step 11, the sound of the voice of the speaker is picked up by way of the microphone 31 of the system 20, either for immediate processing in the system 20 or for delayed processing.

Immediate processing is understood to mean processing carried out as the audio signal is acquired, without an intermediate step of tying this audio signal to any permanent recording medium. The data of the original audio signal then transit only via the random access memory (non-permanent memory) of the system 20.

Conversely, delayed processing is understood to mean processing that is performed based on a recording, made within or under the command of the audio system 20, of the speech signal of the speaker acquired via the microphone 31. This recording is tied to a mass data storage medium, for example a hard drive internal to the system 20. It may also be a peripheral hard drive, that is to say external hard drive, coupled to this system. It may also be another peripheral data storage device with permanent memory capable of permanently storing the audio data of the speech signal, such as a USB stick, a memory card (Flash memory card or the like) or an optical or magnetic recording medium (audio CD, CD-ROM, DVD, Blu-Ray disc, etc.).

The mass data storage medium may also be a data server with which the audio system 20 is able to communicate in order to upload the data of the audio signal so that they are stored there, and to subsequently download said data for subsequent processing. This server may be local, that is to say form part of a local area network (LAN) to which the audio system 20 also belongs. The data server may also be a remote server, such as for example a data server in the cloud that is accessible via the public Internet network.

As a variant, the speech signal corresponding to the speech sequence of the speaker may have been acquired via another equipment, separate from the audio system 20 that implements the method for masking the voice of the speaker. In this case, an audio data file encoding the voice of the speaker may have been recorded on a removable data medium, which may then, in step 11, be coupled to the audio system 20 in order to read the audio data. This audio data file may also have been uploaded to a data server in the cloud, which the audio system 20 is also able to access in order to download the audio data of the audio signal to be processed. In all of these situations, step 11 of the method then consists, for the audio system 20, only in accessing the audio data of the speech signal of the speaker.

In all cases, step 11 of the method comprises (temporally) dividing the original speech signal into a series of successive audio segments of a determined duration, which is constant from one segment to another in the series of segments that is thus produced. Preferably, the audio signal is divided into a series of successive audio segments of the same determined duration by time windowing that is independent of the content of the audio signal and that may be carried out “on the fly”.

The expression “independent of the content of the audio signal” is understood to mean that the windowing is independent both of the frequency content, that is to say of the distribution of energy in the frequency spectrum of the audio signal, and of the information or linguistic content, that is to say of the semantics and/or the grammatical structure of the speech contained in this audio signal in the language spoken by the speaker. The method is therefore very simple to implement, since there is no need for any physical or linguistic analysis of the signal to generate signal segments to be processed.

In signal processing, a time windowing operation makes it possible to process a signal of length intentionally limited to a duration τ, in the knowledge that any computing operation may be carried out only on a finite number of values. To observe or process a signal over a finite duration, it is multiplied by an observation window function, also called weighting window and denoted h(t). The simplest one, but not necessarily the one most commonly used or the one preferred, is the rectangular window (or door) of size m defined as follows:

$$h ( t ) = \{ \begin{matrix}1 , & si t ∈ [ 0 , m ] \\ 0 , & sinon\end{matrix} \qquad ( 1 )$$

Multiplying (numerically computing) the digitized audio signal S(t) by the door function h(t) above, and then offsetting, gives a finite series formed of a determined number N of audio signal segments Sₖ(τ), each of the same fixed duration D, and indexed by the letter k, denoted:

{Sₖ(τ)}_{k=1,2,3, . . . N} (2)

where τ denotes the relative index of time in the segment.

Advantageously, the duration D of an audio segment sₖ(τ) is equal to a fraction of a second, for example between 10 milliseconds (ms) and 100 ms (in other words, D ∈ [10 ms, 100 ms]). An audio segment then has a duration shorter than that of a word in the language spoken by the speaker, regardless of the language in which it is spoken. This duration is a fortiori shorter than the duration of a sentence or even of a portion of a sentence in this language. The duration of an audio segment sₖ(τ) is then at most of the order of the duration of a phoneme, that is to say the duration of the smallest unit of speech (vowel or constant). An audio segment sₖ(τ) therefore does not contain per se any information content with regard to the language spoken, since its duration is far too short for this. This gives the masking method the advantage of simplicity, and also good robustness against the risk of reversion.

It will be noted that such a decomposition of the audio signal S(t) into a series {Sₖ(τ)}_{k=1,2,3, . . . N} of segments, also called elementary frames and indexed by the letter k below, obtained by windowing and shifting, is conventional in signal processing, since it makes it possible to process the signal in successive time slices.

Step 11 also comprises forming a series of pairs of audio segments each

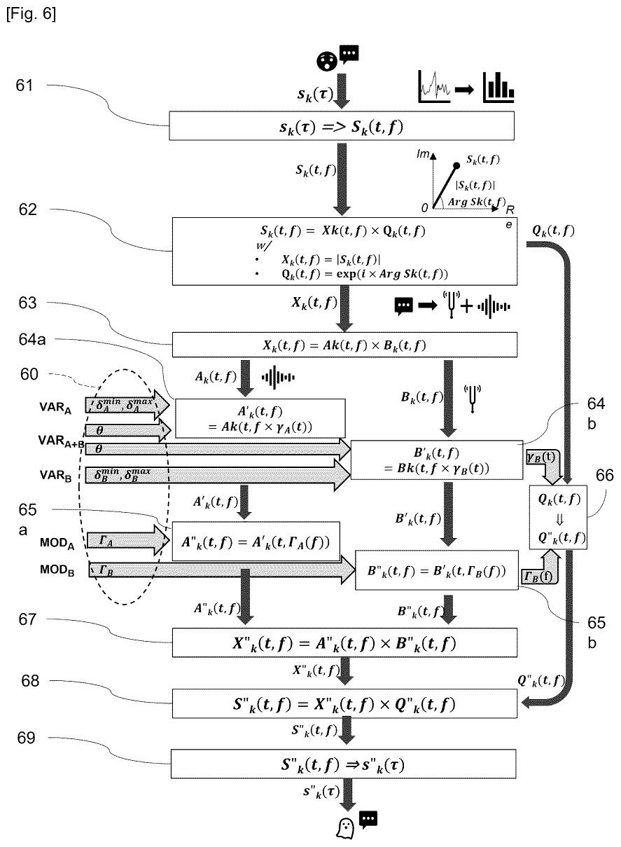

comprising a primary version and a duplicate of an audio segment of the series of audio segments above. As will be seen in more detail later, with reference to the chart of steps in FIG. 6, these pairs may more particularly be defined in the frequency domain, after a Fourier transform (FT) applied to the segments sₖ(τ) of the audio signal in the time domain. In each pair formed by a primary version and a duplicate of a segment of the original speech signal of the speaker, these two elements are identical to one another, and result from the same segment under consideration of the original speech signal of the speaker. Hereinafter and in the figures of the appended drawings, the series of primary versions and the series of duplicates of the audio segments of the speech signal that are thus produced undergo processing operations for each primary version and each duplicate of the audio segment of a pair, in order to extract therefrom the envelope of the harmonics characterizing the timbre of the audio segment, on the one hand, and the signal characterizing the pitch of the audio segment, on the other hand. In FIG. 1, the series of timbres and the series of pitches are denoted indiscriminately by the letters A and B, or vice versa.

For each pair of segments, the signals characterizing the pitch and the timbre

that are extracted from the primary version and from the duplicate undergo parallel processing operations that are for the most part independent of one another. These processing operations are illustrated by steps 12a and 13a of the left-hand branch and by steps 12b and 13b of the right-hand branch, respectively, of the algorithm illustrated schematically by the flowchart of FIG. 1.

Step 12a is a first rising alteration (denoted MODA hereinafter and in the

drawings), applied to each element of the series A of audio segments. This rising alteration is not identical from one element to another of the series A. On the contrary, it evolves as a function of at least one first masking parameter. By contrast, regardless of the evolution of the first masking parameter, this first rising alteration always has the effect of raising a determined portion of the frequency content of the primary version of the audio segment to which it is applied. This is understood to mean that all or some of the frequencies of the primary version of the segment under consideration are moved towards high frequencies, in comparison with the corresponding audio segment of the original speech signal. The application of the first alteration generates an altered timbre (in this case altered upwards) of the audio segment.

Step 12b is for its part a second, falling alteration (denoted MODB hereinafter

and in the drawings), applied to each element of the series B of audio segments. Just like the rising alteration MODA applied to the elements of the series A, this falling alteration MODB is not identical from one element to another of the series B. This means that it evolves, and does so as a function of at least one second masking parameter. By contrast, regardless of the evolution of this second masking parameter, this falling alteration always has the effect of lowering a determined portion of the frequency content of the element of the audio segment to which it is applied. This is understood to mean that all or some of the frequencies of the audio segment under consideration are moved towards low frequencies, in comparison with the corresponding audio segment of the original speech signal. Applying the second alteration generates an altered pitch (here altered downwards) of the audio segment.

It will be noted that it is then advantageous for each of the alterations MOD_{A} and MOD_{B} to be restricted from the point of view of the evolution of the frequency content of the elements of the audio segment to which it is applied. This is understood to mean that these alterations of the frequency spectrum are each only rising or only falling, without any inflection in the direction of movement of the frequencies in question of the spectrum under consideration. Indeed, this makes it possible to prevent the audio system 20 from being able to be used itself by malicious people to whom it may have been provided or made available, or who may have access thereto by any other means, in order to reverse or alter the audio signal. Indeed, such reversion could consist in applying, to the masked audio signal (which the malicious third party may have copied or intercepted in any way), alterations with masking parameters carefully chosen to return to the original speech signal, that is to say to the audio signal corresponding to the natural voice of the speaker. However, by virtue of the modes of implementation described above, such a manoeuvre is not possible with the audio system 20 according to the invention itself. Indeed, no change of the values of the masking parameters of the rising alteration MODA and of the falling alteration MOD_{B} that the malicious third party might try can have the effect of reversing the unidirectional movements in pitch and timbre, respectively, of the original speech signal. In other words, the audio system 20 does not offer the option of reversibility of the alteration that it produces. This does not prevent a malicious third party from attempting this fraud with other means, but at least the system used to mask the audio signal containing the natural voice of a speaker cannot be diverted from its function, in fact “reversed”, so as to lower the protection of the speaker that it makes it possible to provide.

The method then comprises a step 15 of combining the timbre of the audio segment, altered by the alteration MODA and that was obtained in step 12a, on the one hand, and the pitch of the audio segment, altered by the alteration MODB and that was obtained in step 12b, on the other hand, so as to form a single resulting altered audio segment. Combining is understood here to mean an operation having, from the physical point of view, the effect of combining the respective altered spectra, that is to say of fusing the respective frequency content of the altered timbre of the audio segment and the altered pitch of said audio segment, possibly with averaging and/or smoothing. In signal processing, this may be achieved by multiplication (“x” symbol) or by convolution (“*” symbol), either in the time domain or in the frequency domain after transformation of the one or more audio signals from the time domain to the frequency domain through a Fourier transform.

The method furthermore comprises, from one pair of audio segments to another in the series of pairs of audio segments:

in step 13a for the elements of the series A, varying at least one parameter of the alteration MOD_{A}, for example a variation of this alteration within an interval of settable width, this variation being symbolically denoted VAR_{A} hereinafter and in the figures, and;

in step 13b for the elements of the series B, varying at least one parameter of the alteration MOD_{B}, for example a variation of this alteration within an interval of width that is itself settable, this variation being symbolically denoted VAR_{B} hereinafter and in the figures,

said variations of the alterations being variable from one pair of segments to another in the series of pairs of audio segments.

A person skilled in the art will appreciate that, in practice, steps 12a and 12b,

on the one hand, and steps 13a and 13b, on the other hand, may be performed in the order opposite that presented in FIG. 2. In other words, they may be swapped: steps 13a and 13b may be executed after (as shown) or else before steps 12a and 12b.

Preferably, steps 13a and 13b cause a local disturbance, around the time τ, in the (spectral) characteristics of the timbre and of the pitch, said disturbance varying from one segment to another in the series {Sₖ(τ)}_{k=1,2,3, . . . N} (therefore as a function of k) randomly, non-statically (for example, in random steps) and independently on each of the two spectral components, that is to say pitch and timbre.

In one exemplary implementation that is however not limiting, the alteration of

the pitch of the audio signal may thus correspond to an “oriented” variation, that is to say a rise or a fall, of the fundamental frequency of the audio signal, which may take any one of the following determined values: ±6.25%, ±12.5%, ±25%, ±50% and ±100%. These exemplary values correspond approximately to variations of a semitone, of a tone, of a third, of a fifth, or of an octave, respectively, of the pitch (that is to say of the fundamental frequency) of the original speech signal.

The distribution into sequences in step 14 for the successive pairs of primary

versions and duplicates of the audio segments generated in step 11 generates a series of altered audio segments.

The method lastly comprises, in step 15, recomposing the masked audio signal from the series of altered audio segments obtained by the distribution in the previous steps, 12a-12b, 13a-13b and 14.This recomposition is carried out by overlaying and adding, in the time domain, the successive elements of the series of altered audio segments produced in step 14, as they are transformed.

It will be noted that, in the resulting altered audio segment, the frequency content is altered twice in comparison with the spectrum of the segment under consideration of the original speech signal. This results from the accumulation of the respective effects of the functions MOD_{A} and MOD_{B}.

In some modes of implementation, the successive changes of the first masking parameter and of the second masking parameter that take place upon each occurrence of steps 13a and 13b, respectively, lead to random variations of said first parameter and second parameter, from one pair to another in the series of pairs of audio segments that is generated in step 11.

Since the alterations MOD_{A} and MOD_{B} relate to different components of the spectrum of the segment under consideration of the original speech signal, since they also use separate masking parameters, and since finally their respective masking parameters evolve independently of one another and randomly, the masking effect that is obtained is very difficult, if not impossible, to reverse.

The variations of the first and of the second masking parameter thus themselves fluctuate randomly, from one pair of segments to another in the series of pairs of audio segments. In other words, the variations denoted VAR_{A} and VAR_{B} in steps 13a and 13b of the parameters of the modifications denoted MOD_{A} and MOD_{B} introduced in steps 12a and 12b fluctuate as a function of time. In particular, this fluctuation takes place from one segment to another of the original speech signal. Therefore, in FIG. 1, this fluctuation is symbolized by an operation denoted VAR_{A+B} in step 14.

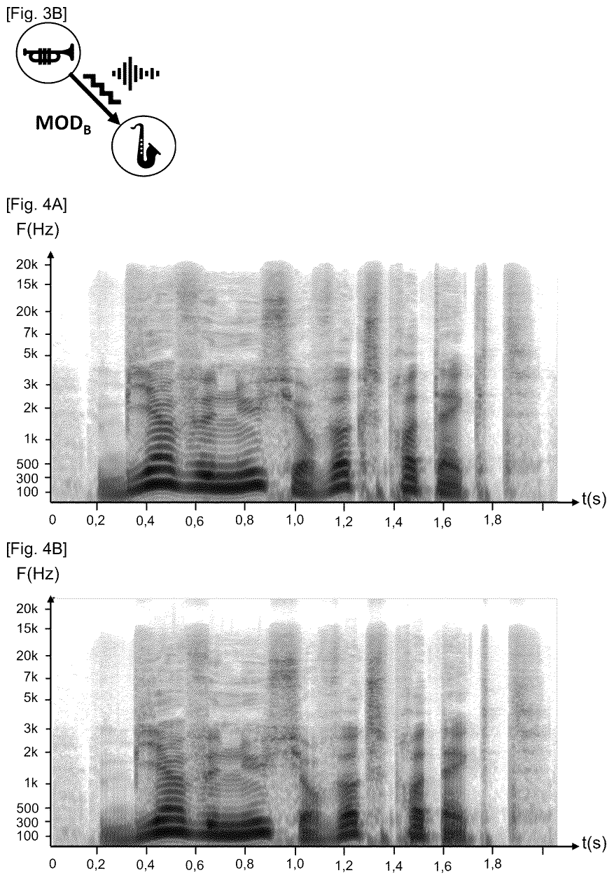

FIG. 3A and FIG. 3B illustrate one mode of implementation of the falling

alteration and of the rising alteration, respectively, which may be applied to the timbre and to the pitch of an audio signal segment, in step 12a and in step 12b, respectively, of the method illustrated by the flowchart of FIG. 1.

In this example, the rising alteration MODA is applied to the pitch of the voice, symbolized in FIG. 3A by a tuning fork. A tuning fork is known to be an object whose acoustic resonance produces a sound having a pure frequency, as is the case in principle for the fundamental frequency (or pitch) of the voice of a human being. Furthermore, the falling alteration MOD_{B} is applied to the timbre of the voice, symbolized in FIG. 4A by the envelope of the frequency spectrum of an audio signal. Of course, the example shown in FIGS. 3A and 3B is not limiting. The rising alteration MODA may, conversely, be applied to the fundamental frequency (pitch), while the falling alteration MODB might be applied to all or part of the envelope of the harmonics (timbre).

In any case, the two alterations MOD_{A} and MOD_{B} each produce movements of certain frequencies (that is to say, in the example under consideration here, the pitch for one and the envelope of the harmonics for the other) in opposing directions in the frequency spectrum (that is to say a rising direction towards high pitches for one, and a falling direction towards low pitches for the other). In the protected audio signal that is obtained, these effects operate in two different directions, allowing good protection while at the same time preserving a certain intelligibility of the audio signal. Indeed, the “masculinizing” effect of a frequency movement towards low pitches that results from the rising alteration MOD_{A} is partly offset by the “feminizing” effect of a frequency movement towards high pitches that results from the falling alteration MOD_{A}. This thus avoids generating a masked signal close to the voice of “Darth Vader”™ or close to the voice of “Mickey Mouse”™

The audio file obtained after implementing the method of FIG. 1 may be transmitted via email, uploaded to social networks or to a website, broadcast on the airwaves, or distributed on any recording medium. The method makes it possible to mask the voice a posteriori, on a recording of the voice of the speaker, as may easily be done with audio-editing software. Since it is offered in the form of a computer program such as a plug-in to be integrated into audio or audiovisual processing software, the method does not make it possible to make audio or video calls with a masked voice.

Provided that the method is implemented on the audio or audiovisual platform with which the voice of the speaker is acquired, the original voice does not travel on any computer network, thereby avoiding any risk of the data corresponding to the unmasked voice being intercepted by a malicious third party.

The computer program that implements the masking method, by performing the corresponding digital processing computing operations, may be included in host software, for example the operating software of an audio processing environment, such as an audio mixing or audiovisual editing console.

The result obtained by implementing the method, that is to say the masked audio signal, may be tied, that is say recorded:

either on a separate track, added “as an insert” to the programme being composed on the audio or audiovisual processing system;

or directly on the original audio file that was processed, for example as a replacement for the data of the original speech signal, so as to remove the original recording of the voice of the speaker and thus guarantee the perpetual protection thereof.

This result is irreversible in audio mode, and cannot be analysed using voice recognition. It is readable immediately, that is to say it is possible to play the audio data file or read the corresponding audio track, in order to listen to the masked audio signal, in particular to verify by ear or by any other available technical means that the original voice of the speaker is no longer recognizable.

FIG. 4A is a frequency graph of a recorded audio sequence, showing the distribution of energy as a function of time (on the abscissa) and of frequency (on the ordinate). FIG. 4B is a frequency graph of the audio sequence of FIG. 4A after implementation of a voice masking method according to the prior art, through a simple pitch shift. Reference is sometimes made to a “pitched” signal to denote the signal that has undergone such shifting. It is clearly seen, by comparing these two frequency graphs, that there is a very strong analogy of the signal harmonics between the original signal and the pitched signal.

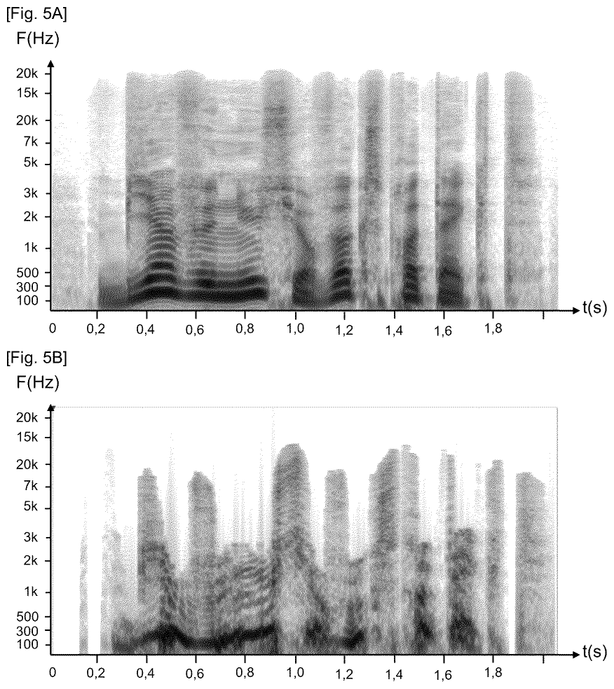

FIG. 5A and FIG. 5B make it possible to compare the frequency graphs of the same audio sequence as FIG. 4A, showing the distribution of energy as a function of frequency before and after, respectively, the implementation of a voice masking method according to the proposed method. This comparison shows that the harmonics of the signal have undergone significant transformations. It may be clearly seen in FIG. 5B that harmonics from FIG. 5A have undergone significant modifications, thus masking the harmonics of the original signal. This masking makes it extremely difficult, if not impossible, to compare the spectrograms of the original speech signal and of the masked speech signal.

Some modes of implementation of the method presented schematically above and in terms of its main steps only will now be described in greater detail with reference to the flowchart of FIG. 6.

Implementing the method consists in applying a digital processing operation,

here for example in the time-frequency domain, which is best suited to this type of computing-based processing operation, to the sequence {sₖ(τ)}_{k=1,2,3, . . .} of segments sₖ(τ) of the digitized speech signal S(t). Such a segment is denoted sₖ(τ) at the top of FIG. 6. A person skilled in the art will appreciate that, in practice, the processing operation illustrated by the diagram of steps in this figure is obviously applied successively to each segment sₖ(τ) indexed by the letter k.

In step 61, the segment sₖ(τ) undergoes a Fourier transform (FT), for example a short-term Fourier transform (known by the acronym STFT), in order to change to the time-frequency domain. Each segment sₖ(τ) of duration τ in the time domain is thus converted so as to give a segment denoted Sₖ(t, f), which takes complex values in the time-frequency domain.

In step 62, the segment Sₖ(t, f) is decomposed into a modulus term denoted Xₖ(t, f) and a phase term denoted Qₖ(t, f). These terms are such that:

Sₖ(t, f)=Xₖ(t, f)×Qₖ(t, f) (3)

where:

Xₖ(t, f)=∥Sₖ(t, f)∥; and,

Qₖ(t, f)=exp(i33 Arg Sₖ(t, f)),s where Arg denotes the argument of a complex number.

The term Xₖ(t, f) corresponds to the power spectral density (PSD) of the

audio signal close to the time t. Based on this term Xₖt, f), it is then possible to determine the fundamental frequency (or pitch) of the speech, that is to say the pitch, on the one hand, and to estimate the envelope of the power spectral density, that is to say the timbre, on the other hand.

More particularly, step 63 comprises forming a pair of segments that are

initially equal to one another and equal to the modulus term Xₖ(t, f) of the segment Sₖ(t, f), and which is called, for the purposes of the present disclosure, the primary version and the duplicate of the segment Sₖ(t, f). Reference will also sometimes be made to series of pairs each formed (that is to say for each value of the index k) by this primary version and this duplicate of the segment Sₖ(t, f). Differentiated processing operations applied to the primary version and to the duplicate, respectively, of the segment thus make it possible to separate the modulus term Xₖ(t, f) into two different components Aₖ(t, f) amd Bₖ(t, f) so as to give, in the time-frequency domain:

Xₗ(t, f)=Aₖ(t, f)×Bₖ(t, f), 4)

where

Aₖ(t, f) corresponds, for the segment of the signal of index k under consideration, to the signal characterizing the timbre of the audio signal; and Bₖ(t, f) corresponds, for this segment, to the signal characterizing the pitch of the audio signal.

For example, the timbre component Aₖ(t, f) may be obtained using the cepstrum method. To this end, an inverse Fourier transform (IFFT, inverse fast Fourier transform) is applied, and this then gives the cepstrum, which is a dual temporal form of the logarithmic spectrum (the spectrum in the frequency domain becomes the cepstrum in the time domain). After this transformation, the fundamental frequency may be computed from the cepstral signal by determining the index of the main peak of the cepstrum, and this gives, by windowing the cepstrum, the envelope of the spectrum that corresponds to the timbre component Aₖ(t, f).

pow The pitch component Bₖ(t, f), for its part, may then be obtained by dividing, point by point, the signal Xₖ(t, f) by the value of the timbre component Aₖ(t, f). In other words, to obtain the pitch component Bₖ(t, f), it is possible to “subtract” (this being done through a division computing operation in the time-frequency space), from the modulus term Xₖ(t, f) of the segment Sₖ(t, f), the contribution Aₖ(t, f) of the envelope of the spectrum so as to obtain “what is left”, which is processed as the (spectrum of the) signal characterizing the pitch or more generally what is called the fine structure of the power spectral density (PSD).

In steps 64a and 65a, on the one hand, and in steps 64b and 65b, on the other hand, rising or falling alterations are then applied to the envelope Aₖ(t, f) of the spectrum corresponding to the timbre and to the fine structure Bₖ(t, f) of the spectrum corresponding to the pitch, using a preferably monotonic transformation along the frequency axis, these alterations being different from one another with regard to their implementation methods, and each also being variable randomly, from one audio signal segment to another. These alterations make it possible to respectively modify the timbre and the pitch of the signal independently and variably over time (non-statically), more particularly from one audio signal segment to another, that is to say as a function of the index k. For each of the timbre and the pitch, this result is obtained overall by multiplying, in the time-frequency domain, the component Aₖ(t, f) or Bₖ(t, f), respectively, of the power spectral density Xₖ(t, f):

on the one hand, by a function altering the frequency scale Γ_{A}(f) or Γ_{B}(f), in step 65a for the timbre component Aₖ(t, f) and in step 65b for the pitch component Bₖ(t, f), respectively, which are preferably monotonic and one of which is rising while the other is falling in relation to its effects on the frequency content of the original audio segment Sₖ(t, f); and,

on the other hand, by a temporal variation function γ_{A}(t) or Γ_{B}(t) applied overall to the frequency scale, in step 64a for the timbre component Aₖ(t, f) and in step 64b for the pitch component Bₖ(t, f), respectively.

The order in which these operations are performed in the time-frequency

domain does not matter. In the implementation shown in FIG. 6, the components Aₖ(t, f) and Bₖ(t, f) are first multiplied by the temporal variation functions γ_{A}(t) and γ_{B}(t), respectively, and the respective results of these first multiplications are then multiplied by the frequency alteration functions Γ_{A}(f) and Γ_{B}(f), in step 65a and in step 65b, respectively. However, these two groups of multiplications could equally well be performed in the opposite order. In other words, steps 65a and 65b could be performed before steps 64a and 64b, respectively.

As will have been understood, and as shown on the left of the blocks

illustrating steps 64a , 64b, 65a and 65b in FIG. 6, in these modes of implementation, the frequency alteration functions Γ_{A}(f) and Γ_{B}(f)correspond to the alterations MOD_{A} and MOD_{B}, respectively, that were presented above with reference to FIG. 1. Likewise, the temporal variation functions γ_{A}(t) and γ_{B}(t) correspond to the variations VAR_{A} and VAR_{B}, respectively, that were presented above with reference to FIG. 1. To avoid any ambiguity, it will be noted that, from the point of view of the frequency spectrum of the original audio segment Sₖ(t, f), what varies over time through the effect of the temporal variation functions γ_{A}(t) and γ_{B}(t) is the overall effect on this spectrum and more particularly on the timbre and on the pitch, respectively, of the combination of the frequency alteration functions Γ_{A}(f) and Γ_{B}(f) and of the temporal variation functions γ_{A}(t) and γ_{B}(t) , respectively, that is to say the accumulation (or the addition) of their respective effects. These respective effects of the combination of the frequency alteration functions Γ_{A}(t) and Γ_{B}(f) and of the temporal variation functions Γ_{A}(t) and Γ_{B}(t) on the frequency spectrum of the original audio segment is related more particularly to the frequency alteration functions Γ_{A}(f) and Γ_{B}(f) , respectively, the temporal variation functions γ_{A}(t) and γ_{B}(t) having the effect only of varying these, preferably randomly, in order to increase the robustness of the masking in the face of reversion attempts resulting from a malicious intention.

In the example shown in FIG. 6, step 64a comprises applying, to the signal Aₖ(t, f) that corresponds to the timbre component, on the frequency scale f, the temporal variation function γ_{A}(t), so as to generate an intermediate signal, denoted A′ₖ(t, f), of the timbre component Aₖ(t, f). This operation may be written as a multiplication in the time-frequency domain as follows:

A′ₖ(t, f)=Aₖ(t, f)×γ_{A}(t)) (5a)

The function γ_{A}(t) is a linear function. Preferably, and as was already mentioned above, it fluctuates randomly over time, varying from one original audio signal segment to another in the series of segments Sₖ(t, f) that are processed in sequence. In other words, it changes as a function of the value of the index k, in accordance with a random process the refreshing of which is governed by a parameter θ, such that the alteration of the timbre is not static.

In the same way, step 64b comprises applying, to the signal Bₖ(t, f) that

corresponds to the pitch component, on the frequency scale f, the temporal variation function γ_{B}(t), so as to generate an intermediate signal, denoted B′ₖ(t, f). This operation may be written as a multiplication in the time-frequency domain as follows:

B′ₖ(t, f)=Bₖ(t, f×γ_{B}(t ) (5b)

The function γ_{B}(t) is a linear function. Preferably, and as was already mentioned above, it fluctuates randomly over time, varying from one original audio signal segment to another in the series of segments Sₖ(t, f) that are processed in sequence. In other words, it changes as a function of the value of the index k, in accordance with a random process the refreshing of which is governed by a parameter θ, such that the alteration of the pitch is not static.

The fluctuations, as a function of time, of the temporal variation function γ_{A}(t)

applied to the timbre component and/or of the temporal variation function γ_{B}(t) applied to the pitch component, and all the more so when one and/or the other of these fluctuations are random, make it possible to increase the irreversibility of the voice masking method.

For example, the temporal variation function γ_{A}(t) may vary with a random

step within a determined amplitude range [δ_{A} ^{min},δ_{A} ^{max}] and with a temporal refresh rate corresponding to the abovementioned parameter θ, where δ_{A} ^{min}, δ_{A} ^{max} and θ are first masking parameters associated with the temporal variation function γ_{A}(t).

In the same way, the temporal variation function γ_{B}(t) may for example vary

with a random step within an amplitude range [δ_{B} ^{min},δ_{B} ^{min}] and with a temporal refresh rate corresponding to the abovementioned parameter θ, where δ_{B} ^{min},δ_{B} ^{max} and θ are second parameters associated with the temporal variation function γ_{B}(t). The fluctuations of the two temporal variation functions γ_{A}(t) and γ_{B}(t) are preferably independent of one another, in order to increase the irreversibility of the alterations. In other words, the temporal variation functions γ_{A}(t) and γ_{B}(t) are not correlated.

It will be appreciated that the parameter 0 is the parameter of the fluctuation

denoted VAR_{A+B} in FIG. 1. This parameter defines for example the number of random variations per second of the alterations of the spectrum of an audio segment. For example, if θ were equal to zero, the variations VAR_{A} and VAR_{B} are static, such that the results of the alterations MOD_{A} and MOD_{B} would be fixed, which is not the case in practice. In one example, θ has a value between 1 and 10. Since this value is homogeneous with a frequency, it may be stated that θ is between 1 and 10 Hz. This value is lower than the frequency of the temporal division of the original speech signal into audio segments (by windowing), which is more of the order of 100 Hz.

Next, in steps 65a and 65b, frequency alteration functions Γ_{A}(f) and Γ_{B}(f), respectively, are applied to the timbre component Aₖ(t, f) and to the pitch component Bₖ(t, f), respectively, so as to generate a timbre component of the masked audio segment, denoted A″ₖ(t, f), and a pitch component of the masked audio segment, denoted B″ₖ(t, f), respectively. These frequency alteration functions Γ_{A}(f) and Γ_{B}(f) correspond to the alterations denoted MODA and MODB in FIG. 1.

These operations may each be written as a multiplication in the time-frequency domain as follows:

A″hd k(t, f)=A′ₖ(t,Γ_{A}(f)) (6a)

B″hd k(t, f)=B′ₖ(t,Γ_{B}(f)) (6b)

The function Γ_{A}(f) and the function Γ_{B}(f) may be linear or non-linear deformation functions for the frequency axis. If one and/or the other are linear, this gives:

Γ_{A}(f)=f×Γ_{A} (7a)

and/or, respectively,

Γ_{B}(f)=f×Γ_{B} (7b)

Preferably, the alteration functions Γ_{A}(f) and Γ_{B}(f) are monotonic, that is to say that the deformation that they introduce on the frequency axis is either rising, with the effect of raising a determined portion of the frequency content of the audio segment sₖ(τ), or falling, with the effect of lowering a determined portion of the frequency content of the audio segment sₖ(τ). Moreover, they are restricted in an opposing direction in the sense that, if one is monotonic rising, the other is monotonic falling, and vice versa. This makes it possible to prevent the software that implements the masking method from being able to be used itself to attempt to reverse the method for masking the voice of the speaker, as has already been explained above with reference to steps 12a and 12b of FIG. 1.

Furthermore, the fact that, out of the alteration functions Γ_{A}(f) and Γ_{B}(f) , one is a rising alteration function, while the other is a falling alteration function, makes it possible to preserve the intelligibility of the voice after masking, since the one or more frequency movements towards high pitches, on the one hand, and the one or more frequency movements towards low pitches, on the other hand, that they produce partially compensate for one another, avoiding excessive voice distortion, which would otherwise be predominant in the masked audio signal.

One of the advantages of the method stems from implementations in which these modifications MODA and MODB are varied for the successive indices k in two non-correlated random sequences (one for the timbre and the other for the pitch), so as to continuously modify these two voice characteristics independently, unpredictably and non-statically. Unlike methods where the modification might be constant, this makes it impossible to reverse the method once the frequency variations are carried out. The protection is greater when the random variations VAR_{A} and VAR_{B} are greater.

The following two steps make it possible to keep the temporality of the original by re-synthesizing the audio signal that is masked by the index k.

Step 67 thus comprises reconstructing each modified audio segment, denoted X″ₖ(t, f), in the time-frequency domain, by combining the new envelope A″ₖ(t, f) and the new fine structure of the frequency spectrum B″ₖ(t, f) of the audio segment under consideration. The term “new” used here with reference to the envelope and to the fine structure signifies that this involves the envelope and the fine structure after masking, that is to say after applying the frequency alteration functions Γ_{A}(f) Γ_{A}(f) corresponding to the alterations MOD_{A} and MOD_{B}, respectively, and the temporal variation functions γ_{A}(t) and γ_{B}(t), respectively. This reconstruction may be achieved by multiplying, in the time-frequency domain, the new timbre component A″ₖ(t, f) by the new pitch component B″ₖ(t,f) of the frequency spectral density (PSD) of the masked audio segment as follows:

X″ₖ(t, f)=A″ₖ(t, f)×B″ₖ(t, f) (8)

Step 68 comprises recomposing each masked audio segment, denoted S″ₖ(t, f), in the time-frequency domain. This recomposition may be achieved by multiplying, in the time-frequency domain, the modulus component X″ₖ(t, f) by the corrected phase component Q″ₖ(t, f) of the masked audio segment S″ₖ(t, f) as follows:

S″ₖ(t, f)=X″(t, f)×Q″(t, f) (9)

The corrected phase component Q″ₖ(t, f) of the masked audio segment

S″ₖ(t, f) is obtained, in the example shown in FIG. 6, in step 66 from the phase term Qₖ(t, f) of the audio segment under consideration Sₖ(t,f), which phase term was generated in step 62. Step 66 has the role of making a correction to the phase term Qₖ(t,f) of the audio segment Sₖ(t, f) as a function of the random variations γ_{B}(t) and of the alteration function Γ_{B}(f) that were applied to the pitch term B(t, f). This makes it possible to ensure temporal continuity of the phase Φ″ₖ(t, f), of the masked audio segment S″ₖ(t, f), that is to say the continuity of the phase ϕ″ₖ(t, f) of this segment with Φₖ(t−1, f), where Φ″ₖ(t, f) corresponds to Arg S″ₖ(t, f).

It will be noted that such a phase correction is known per se and is generally

implemented in any signal transformation processing operation provided that the power spectral density of a signal is modified. In the modes of implementation proposed here, it is generated in step 66 as a function only of the modifications made to the pitch component B″ₖ(t, f) of the power spectral density of the masked audio segment S″ₖ(t,f) with respect to the pitch component Bₖ(t, f) of the power spectral density of the original audio segment Sₖ(t, f). Indeed, for the most part, it is the modifications made to the pitch that call on a phase recalibration of the frequency components of the spectrum. Nevertheless, a person skilled in the art will appreciate that the phase recalibration in step 66 could also take into account modifications made to the timbre component A″ₖ(t, f) of the frequency spectral density of the masked audio signal S″ₖ(t,f) with respect to the timbre component Aₖ(t, f) of the frequency spectral density of the original audio signal Sₖ(t, f). This is not shown in the flowchart of FIG. 6 so as not to overload it, which would make it more difficult to read, but a person skilled in the art understands, on the basis of their usual knowledge and in light of the indications provided here, the way in which this may be implemented in practice.

Once the masked audio segment S″ₖ(t, f) has been obtained through

computing operations in the time-frequency domain as explained above, all that is left is to return it to the time domain, this being carried out in step 69. This step consists in generating the masked signal s″ₖ(τ) in the time domain, from the signal S″ₖ(t, f) in the time-frequency domain. For example, this may be achieved using an OLA (overlap and add) method on the successive inverse Fourier transforms of s″ₖ(τ). The OLA method, also called overlap and add method, is based on the linearity property of the linear convolution, the principle of this method consisting in decomposing the linear convolution product into a sum of linear convolution products. Of course, other methods may be considered by a person skilled in the art to carry out this inverse Fourier transform in order to generate s″ₖ(τ) in the time domain from S″ₖ(t,f) in the time-frequency domain.

The method that has been presented in the above description may be

implemented by a computer program, for example as a plug-in that may be integrated into audio or audiovisual processing software.

In FIG. 6, the reference 60 collectively denotes the parameters for masking

the voice of a speaker, specifically δ_{A} ^{min}, δ_{A} ^{max}, δ_{B} ^{min}, δ_{B} ^{max}, θ, Γ_{A} and Γ_{B}, which may be adjusted by a user via an appropriate human-machine interface of the apparatus on which the software for masking the voice of a speaker is executed.

1. A method for masking the voice of a speaker in order to protect their identity and/or their privacy by intentionally altering the pitch and the timbre of their voice, said method comprising the steps of:
dividing an audio signal corresponding to an original recording of the voice of the speaker into a series of successive audio segments of a determined constant duration, and forming a series of pairs of audio segments each comprising a primary version and a duplicate of an audio segment of said series of audio segments; and, for each pair of audio segments:
processing the primary version of the audio segment and processing the duplicate of the audio segment in order to extract therefrom a signal characterizing the pitch of the audio segment, on the one hand, and a signal characterizing the timbre of the audio segment, on the other hand;
a first alteration, applied to the signal characterizing the timbre extracted from the audio segment, and having the effect of altering all or part of the envelope of the harmonics of said audio segment, so as to generate an altered timbre of the audio segment;
a second alteration, applied to the signal characterizing the pitch of the audio segment, and having the effect of altering the value of the fundamental frequency, so as to generate an altered pitch of the audio segment;
one of the alterations out of the first alteration and the second alteration being a rising alteration, while the other alteration is a falling alteration, and
combining the altered timbre of the audio segment and the altered pitch of the audio segment, so as to form a resulting altered audio segment,
the method furthermore comprising, from one pair of audio segments to another in the series of pairs of audio segments:
varying the first alteration; and
varying the second alteration,
said variations of said first and second alterations fluctuating randomly from one pair of segments to another in the series of pairs of audio segments, and the method furthermore comprising:
recomposing a masked audio signal from the series of altered audio segments.

2. The method according to claim 1, wherein the audio signal is divided into a series of successive audio segments of a determined duration by time windowing independent of the content of the audio signal.

3. The method according to claim 1, wherein the division of the audio signal is configured such that the duration of an audio segment is equal to a fraction of a second, such that successive changes of the first parameter and of the second parameter occur multiple times per second.

4. The method according to claim 1, wherein the first alteration corresponds to varying the fundamental frequency of the audio signal by any one of the following values: ±6.25%, ±12.5%, ±25%, ±50% and ±100%.

5. A computer program comprising: instructions that, when the computer program is loaded into the memory of a computer and is executed by a processor of said computer, cause the computer to implement all of the steps of the method according to claim 1.

6. An audio or audiovisual processing device comprising: means for implementing all of the steps of the method according to claim 1.

7. The audio or audiovisual processing apparatus such as an editing and/or mixing console for producing audio, audiovisual or multimedia content corresponding to or incorporating a speech signal of a speaker, in particular of a

6. to be protected, the apparatus comprising a device according to claim 6.
